(19) United States
(12) Patent Application Publication
(10) Pub. No.: US 2020/0258333 A1
(43) Pub. Date: Aug. 13, 2020

(54) WIRELESSLY ACTUATED DOOR BLOCK

(71) Applicant: Cameron Paine, Madison, CT (US)

(72) Inventor: Cameron Paine, Madison, CT (US)

(21) Appl. No.: 16/270,409

(22) Filed: Feb. 7, 2019

(51) Int. Cl. G07C 9/00; E05B 47/00; E05B 57/00

(52) U.S. Cl. CPC G07C 9/00817; E05B 17/10; E05B 57/00; E05B 47/00

(57) ABSTRACT

A wirelessly controlled door stop is disclosed. In particular, the door stop can include a body portion and a rotatable stop along with a microprocessor and a wireless transceiver. When proper authorization is received the microprocessor activates the rotatable stop, which then rotates from within the body portion to a deployed position that will prevent access to a doorway in which the door stop has been installed. Additionally, the access to the door stop can be logged by a cloud system, which can be accessed by the door stop by the Internet.

### CROSS REFERENCE TO RELATED APPLICATIONS

NONE.

### FIELD OF THE DISCLOSURE

The present disclosure relates to a door block, which can be used to securely restrict access via a doorway. More specifically, the present disclosure relates to a wirelessly activated door block, and more specifically still, a door block that can be activated via input of a proper, individually assigned code on a smart phone or other wireless device.

### DESCRIPTION OF BACKGROUND

Restricting access to doorways is generally accomplished through the use of a lock. However, the installation of a lock on a door is an intrusive procedure that, in many instances, is inconvenient to perform and requires professional assistance. For example, when a house is put up for sale and listed with a listing service (such as the MLS), various realtors must be given access to the house. The typical way this is accomplished is with a “lockbox,” which is placed on the exterior of the premises and contains the keys to the house. Typically, a realtor is assigned a code that is input to the lock box, which then releases the keys. The code assigned to the realtor is logged.

Similar “lockbox arrangements” are used in other circumstances, such as to give contractors access to a property. One problem with the use of a lockbox is that once the lockbox is opened, the key can be lost, stolen, copied, or used to unlock the property and leave it locked. Accordingly, while access to the lockbox is logged, access to the property is not.

Another issue with the use of a lockbox is that the code can be used to access the lockbox at any time. For example, in certain circumstances, a homeowner may desire to limit access to a home during certain hours. However, many Iockboxes do not allow any restrictions to be set; once a person has the key, s/he is free to do anything with it.

Another issue with the use of a lockbox is that access to the lockbox is controlled by the Realtor without administrative control or access control to permit family members or other desired individuals on demand access being provided to the homeowner. Similarly, removal of a lockbox from a property can only be accomplished by the Realtor or listing service.

When attempting to force entry through a door with a lock, typically the weakest part of the door is where the door and the door frame have had significant holes drilled into them to install lock hardware, thus weakening their integrity.

Another issue with the use of the lockbox is that the lockbox is located outside the door and may be exposed to the elements and physical tampering.

### Objects of the Disclosed System, Method, and Apparatus

Accordingly, it is an object of this disclosure to provide a door block.

Another object of this disclosure is to provide a secure door block.

Another object of this disclosure is to provide a secure door block that can be wirelessly controlled.

Another object of this disclosure is to provide a secure door block that can be mounted to a door frame by an L-bracket.

Another object of this disclosure is to provide a secure door block that can be installed without professional assistance.

Another object of this disclosure is to provide a secure door block that is physically located within the property and not exposed to the elements or physical tampering.

Another object of this disclosure is to provide a secure door block that can be controlled via a smartphone.

Another object of this disclosure is to provide a system by which access via a secure door block is tightly monitored.

Another object of this disclosure is to provide a system by which access via a secure door block is only allowed to certain individuals.

Another object of this disclosure is to provide a system by which access via a secure door block is only allowed during certain times.

Another object of this disclosure is to provide a system by which administrative privileges to provide access via a secure door block can be controlled by both a real estate agent and a homeowner.

Other advantages of this disclosure will be clear to a person of ordinary skill in the art. It should be understood, however, that a system, an apparatus or a method could practice the disclosure while not achieving all of the enumerated advantages, and that the protected disclosure is defined by the claims.

### SUMMARY OF THE DISCLOSURE

Generally speaking, pursuant to the various embodiments, the present disclosure provides a door stop. In particular, the door stop includes a body portion as well as a microprocessor disposed within the body portion. In addition, the door stop includes a rotatable stop that is adapted to rotate from within the body portion to a deployed position. When in the deployed position the door stop can operate to block the opening of a doorway.

The door stop can also include an L-bracket having a first face and a second face. The first face includes a plurality of mounting holes, allowing for mounting the door stop to a door frame. The second face can include a pair of screw holes as well, allowing the body portion of the door stop to be screwed to the L-bracket.

The door stop can also include a wireless transceiver coupled to the microprocessor as well as a memory for storing at least one access code. The wireless transceiver can couple with a wireless device, such as a smart phone, and receive an input code. The microprocessor then compares the input code to the access code, and if a match is found, operates the door stop, either granting or restricting access to the doorway.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a front view of a door stop constructed in accordance with this disclosure that has been installed in a doorway.

FIG. 2 is a front perspective view of a door stop constructed in accordance with this disclosure that has been installed in a doorway.

FIG. 3 is a front view of a door stop constructed in accordance with this disclosure illustrated while in the process of rotating from an active position to an inactive position.

FIG. 3A is a front view of a door stop constructed in accordance with this disclosure illustrated in the active position.

FIG. 4 is a front perspective view of an L bracket used to mount the disclosed door stop to a door frame.

FIG. 5 is a simplified block diagram of the internal structure of a door stop constructed in accordance with this disclosure.

FIG. 6 is a simplified network diagram of a system for utilizing the disclosed door stop to grant and restrict access to at least one doorway in which the door stop has been installed.

FIG. 7 is a front view of an alternative door stop constructed in accordance with this disclosure that has been installed in a doorway.

FIG. 8 is a front perspective view of an alternative door stop constructed in accordance with this disclosure that has been installed in a doorway.

FIG. 9 is a front view of an alternative door stop constructed in accordance with this disclosure that has been installed in a doorway, and illustrated in an inactive state.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

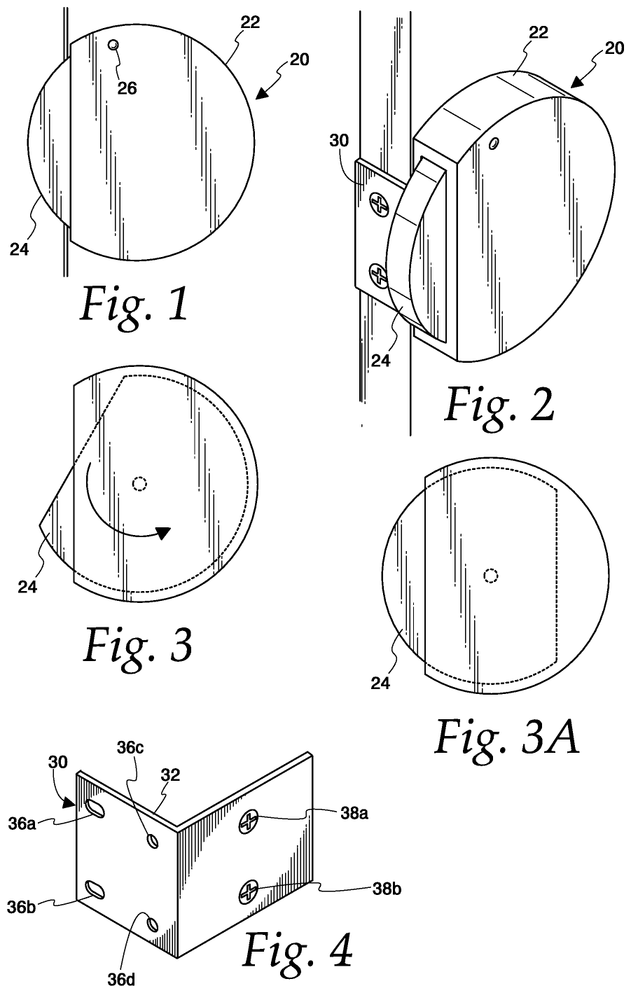

Turning to the Figures, and to FIG. 1 in particular, a front view of an installed door block 20 constructed in accordance with this disclosure is depicted. In particular, the door block 20 comprises a body portion 22 and a rotatable stop 24. As discussed herein, the rotatable stop 24 operates to rotate within the body portion 22 or to its deployed position. An LED 26 provides status information about the door block 20, including, for example, battery status, a low battery indication, an indication as to when the door block 20 is operating, etc.

FIG. 2 depicts a perspective view of the door stop 20 in its activated form; i.e., with the rotatable stop 24 stored in the body portion 22 of the door stop 20. In addition, a simple L-bracket 30 is mounted to the door by two or more screws, and is also coupled to the body portion 24 of the door stop. The L-bracket 30 can be coupled to the body portion 24 of the door stop by, for example, a pair of screws (not shown), glue, welding, or some other means.

Turning to FIG. 3, the rotation of the rotatable stop 24 is depicted. In particular, the rotatable stop 24 is coupled to the body portion 22 by an axle 26. As explained further herein, the rotation of the rotatable stop 24 is conducted by an actuator, such as a stepper motor (not shown). In addition, FIG. 4 depicts an L bracket 30, which comprises a frame face 32 and a body face 34. The frame face 32 includes a pair of oblong mounting holes 36a,b, which allows for flexible placement of a mounting screw (not shown), as well as a pair of fixed mounting holes 36c,d, which are adapted to hold the frame face 32 firmly in place. The body face 34 also includes a pair of mounting holes 38a,b. It should be noted that the mounting holes 38a,b on the body face 34 are optional, and the L-bracket 30 can be coupled to the body portion 22 of door stop 20 via other means as discussed above.

Typically, the door stop 20 will be installed to a door frame via the L-bracket 30. In particular, the door stop 20 is mounted to the door frame so that the door stop 20 is disposed on the inside, with the door being allowed to open internally freely when the door stop 20 is not activated; i.e., when the rotatable stop 24 is in its stowed position. When the door stop 20 is activated, the rotatable stop rotates into a deployed position (as seen if FIG. 1), thereby preventing the door from swinging past, and maintaining it in a locked position.

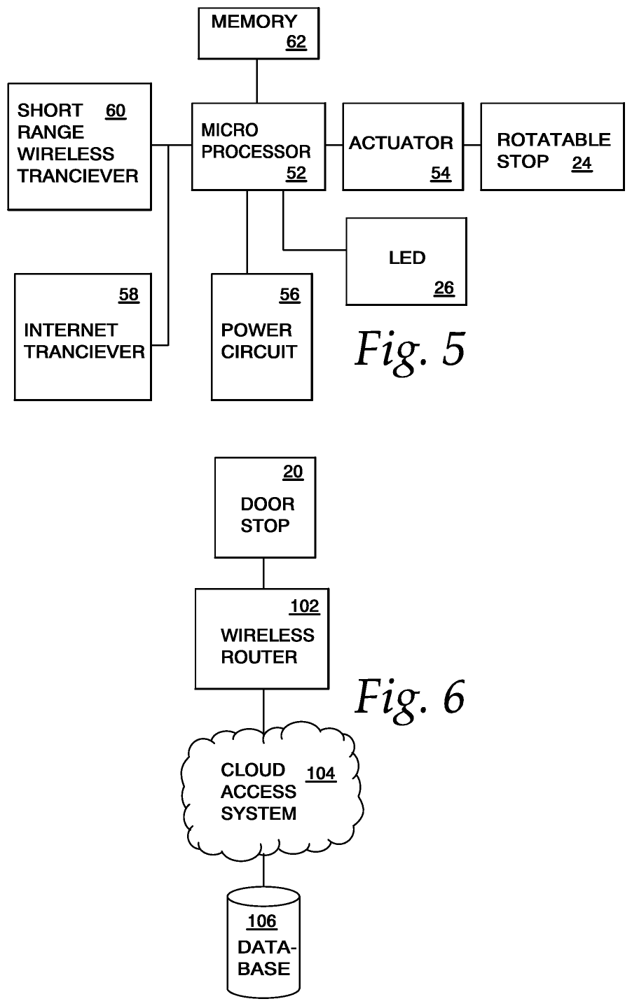

Turning to FIG. 5, a simplified block diagram depicting the internal structure of the door stop 20 is shown. In particular, the door stop 20 comprises a microprocessor or microcontroller 52. The microprocessor 52 is coupled to an actuator 54 which controls the rotation of the rotatable stop 24. The microprocessor 52 is also coupled to an LED 26, which allows for the display of status information. In one embodiment, the LED 26 can be a multicolor LED, which would allow for easier display of varied data. The microprocessor 52 is also coupled to a short-range wireless transceiver 60, which can be, for example, a Blue Tooth transceiver, or a different type of short-range radio capable of communicating with control devices, such as smartphones. In addition, the microprocessor 52 is coupled to an Internet transceiver 58, such as, for example, an 802.11 wireless transceiver, or a cellular transceiver. The purpose of the Internet transceiver 58 is to allow for communication with remote devices. Further, the microprocessor 52 is coupled to memory 62, which is used to store the codes by which the door stop 20 will allow access, as well as access rules, such as certain time periods during which access will not be permitted. Finally, a power circuit 56 provides power for the entire door stop 20.

The short-range transceiver 60 and the Internet transceiver 58 can be a single transceiver in certain embodiments; for example, all control can be provided via the Internet using the system disclosed below. The actuator 54 can be, for example, a stepper motor, which will require appropriate circuitry. In addition, the rotatable stop 24 can include mechanical cutoffs placed appropriately to prevent its rotation beyond appropriate limits. The memory 62 can be, for example, FLASH memory or electrical erasable memory, or any other type of memory that can hold information persistently. The power circuit 56 can be, for example a battery along with an appropriate charging circuit.

Turning to FIG. 6, a system for controlling and utilizing the disclosed door stop 20 is disclosed. The system includes at least one door stop 20, which is optionally coupled to a wireless router 102, if the system utilizes broadband Internet provided by a home owner. In another embodiment, the door stop 20 will communicate directly with the cloud access system 104. The cloud access system 104 will communicate with a database 106 as described herein. It should be understood that the disclosed system ideally will accommodate many—thousands or even many tens of thousands—of door stops 20 (and optionally wireless routers 102), all communicating with the cloud access system 104 as set forth below.

In standard operation, the memory 62 will have a number of access codes and access rules. A person seeking access, such as a real estate agent, will connect a wireless device, such as a smart phone, to the door stop 20 using the short-range wireless transceiver 60. The smart phone (not shown) can use, for example, a custom application to interface with the door stop 20. Once the wireless device is connected to the door stop 20, the user can input a code, which the microprocessor 52 will then check against the codes stored in the memory 62. Alternatively, other means of authentication, such as a biometric scanner, could be employed to authenticate users. If the code matches a stored code, the door stop 20 will grant access. At the same time the door stop 20 will transmit the access to the cloud access system 104, where the access will be logged in the database 106.

Once the user no longer requires access, the user can use a wireless device to reset the door stop 20 in its locked state. In certain embodiments, the door stop can automatically reset after a certain time period, or generate an alarm to the cloud access system 104, which can dispatch a person to ensure that the premises is secured.

In at least one embodiment, the access codes and access rules can be stored in the database 106 rather than in a local memory 62. In such an embodiment, an access code along with an identifier for the particular door stop 20 would be transmitted to the cloud access system 104, which would then check the code against those stored in the database 106, along with any applicable access rules before sending a message back to the door stop either granting or denying access.

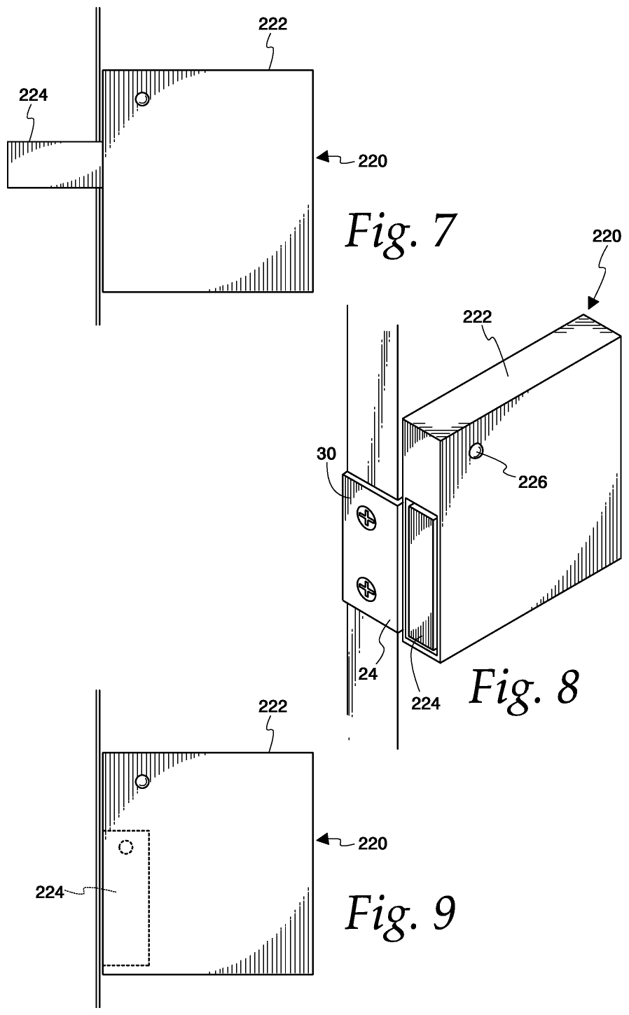

While the first disclosed embodiment involved a rotating semi-circular or oval stop, other embodiments are also possible within the disclosed operative principles. For example, turning to FIGS. 7-9, an alternative embodiment is disclosed. In the alternative embodiment, the door stop 220 comprises a housing 222 and a stop 224. The stop 224 rotates, although it could also extrude or withdraw linearly. In addition, an indicator 226, such as an LED, provides status information. Turning to FIG. 8, the alternative door stop 220 is shown attached to a door frame with the stop 224 rotated to its inactive position, and FIG. 9 shows a front view of the door stop 220 with the stop 224 visible inside of the housing 222 in its inactive position.

Obviously, many additional modifications and variations of the present disclosure are possible in light of the above teachings. Thus, it is to be understood that, within the scope of the appended claims, the disclosure may be practiced otherwise than is specifically described above

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A door stop comprising:
a body portion;
microprocessor disposed within the body portion; and
a rotatable stop disposed within the body portion and coupled to the microprocessor;
wherein the rotatable stop is adapted to rotate from within the body portion to a deployed position.

2. The door stop of claim 1 further comprising an L bracket having a first face and a second face, wherein the first face includes two or more oblong mounting holes, and the second face is coupled to the body portion.

3. The door stop of claim 2 further comprising:
a wireless transceiver coupled to the microprocessor, the wireless transceiver being adapted to communicate with a wireless device and receive an input code;
a memory for storing at least one access code, the memory being coupled to the microprocessor;
wherein the microprocessor receives the input code and compares it to the at least one access code, and as a result of the comparison generates a signal that causes the rotatable stop to rotate from within the body portion to the deployed position.

4. The door stop of claim 3 further comprising a power circuit including a battery and a battery charger.

5. The door stop of claim 4 further comprising an indicator that displays a low battery indication.

6. The door stop of claim 4 wherein the microprocessor is adapted to send a message to a cloud access system indicating a particular time and input code that resulted in the rotation of the rotatable stop.

7. The door stop of claim 6 wherein the message is logged in a database by the cloud access system.
